(19) United States
(12) Patent Application Publication
(10) Pub. No.: US 2006/0145465 A1
(43) Pub. Date: Jul. 6, 2006

(54) Separable sheet system and method

(75) Inventors: Susan L. Hilger, Las Vegas, NV (US); Joseph M. Hilger, Las Vegas, NV (US)

Correspondence Address: DAVIS WRIGHT TREMAINE, LLP, 2600 CENTURY SQUARE, 1501 FOURTH AVENUE, SEATTLE, WA, 98101-1688, US

(73) Assignee: Abbondante, LLC, Las Vegas, NV (US)

(21) Appl. No.: 11/028,989

(22) Filed: Jan. 3, 2005

(51) Int. Cl. B42D 1/00

(52) U.S. Cl. 281/21.1

(57) ABSTRACT

A separable sheet system utilizing one or more separable sheets removably affixed to an associated bound sheet of a collection of bound sheets such as a book, magazine, pamphlet, brochure, or other publication. The separable sheet system generally provides a mechanism for users of information contained in a bound collection of sheets to remove a separable sheet removably affixed to an associated one of the bound sheets. The separable sheet contains information, such as an accurate list of ingredients, to be used elsewhere without the necessity of taking the entire book, magazine, or other type of bound collection of sheets along or without the necessity of resorting to the error prone procedure of transcribing information.

### BACKGROUND OF THE INVENTION

1. Field of the Invention

The present invention relates generally to a volume such as a book, periodical, brochure, or other information containing sheet collections.

2. Description of the Related Art

Every year thousands of cookbooks are purchased by readers, many of whom actually prepare the recipes listed in the cookbook. Diet cookbooks, health-related cookbooks, and celebrity chef cookbooks often contain ingredients not commonly found in the reader's pantry. Unfortunately, the cookbook user must either awkwardly carry a obtrusive book on shopping trips or diligently compile a shopping list of all the needed ingredients, complete with the exact amounts, weights, or sizes of the ingredients before venturing into the grocery store. Similar procedures are demanded of users of books and periodicals containing other information including other sorts of instructions, parts or material lists, exercise routines, plans, lessons, or samples such as pattern or color samples.

### BRIEF SUMMARY OF THE INVENTION

Aspects of the present invention reside in a system having a plurality of printed sheets, one of the plurality of sheets being an associated sheet, the associated sheet having an overlaid portion, and a separable printed sheet having a first identification of one or more articles, the separable printed sheet being removably affixed to the overlaid portion of the associated sheet.

Further aspects include the separable printed sheet having the first identification to include at least one of the following: text and graphics. Other aspects include the overlaid portion of the associated sheet is printed with the first identification. The plurality of printed sheets is bound or is configured to be a portion of one of the following: a book and a magazine. The separable printed sheet has the first identification of articles as food items, and/or has the first identification of articles as materials, and/or has the first identification of articles as actions to be performed, and/or has the first identification of articles as ingredients, or has the first identification of articles as portions of lessons, and/or has the first identification of articles as exercise positions, and/or has the first identification of articles as planned events and/or has the first identification of articles as tasks, and/or has the first identification of articles as color samples, and/or has the first identification of articles as paint samples, and/or has the first identification of articles as parts, and/or is made from at least one of the following materials: paper, acrylic, and plastic, and/or is removably attached to the overlaid portion of the associated sheet by pressure-sensitive adhesive, and/or is repositionable removable media, and/or is non-repositionable removable media.

Other features and advantages of the invention will become apparent from the following detailed description, taken in conjunction with the accompanying drawings.

### BRIEF DESCRIPTION OF THE SEVERAL VIEWS OF THE DRAWING(S)

FIG. 1 is a schematic diagram showing a bound collection of sheets having a separable sheet system for a generally represented information list according to the present invention.

FIG. 2 is a schematic diagram of the bound collection of sheets of FIG. 1 with a separable sheet of the separable sheet system shown removed.

FIG. 3 is a schematic diagram of the bound collection of sheets of FIG. 1 with two separable sheets of the separable sheet system shown removed.

FIG. 4 is a schematic diagram showing a second implementation of the separable sheet system for a representative set of instructions with a separable sheet shown removed.

FIG. 5A is a schematic diagram showing a third implementation of the separable sheet system for a representative recipe with a separable sheet shown removed.

FIG. 5B is a schematic diagram showing a fourth implementation of the separable sheet system for a representative instruction list with a separable sheet shown removed.

FIG. 5C is a schematic diagram showing a fifth implementation of the separable sheet system for a representative combination of two parts showing a separable sheet shown removed.

FIG. 6 is a schematic diagram showing a sixth implementation of the separable sheet system for a representation of exercises with a separable sheet shown removed.

FIG. 7 is a schematic diagram showing a seventh implementation of the separable sheet system for a representative materials list with a separable sheet shown removed.

FIG. 8 is a schematic diagram showing a eighth implementation of the separable sheet system for a representative set of plans with a separable sheet shown removed.

FIG. 9A is a schematic diagram showing a ninth implementation of the separable sheet system for a representative fabric swatch with a separable sheet shown removed.

FIG. 9B is a schematic diagram showing a tenth implementation of the separable sheet system for a representative color samples with sheets for two different color samples shown removed.

FIG. 10 is a schematic diagram showing an eleventh implementation of the separable sheet system for a representative lesson set with a sheet shown removed.

FIG. 11 is a schematic diagram showing a twelfth implementation of the separable sheet system having a separable sheet with a pull tab, the separable sheet being removably attached to a bound collection of sheets.

FIG. 12 is a schematic diagram showing the twelfth implementation of the separable sheet system with the separable sheet removed from the bound collection of sheets.

### DETAILED DESCRIPTION OF THE INVENTION

A separable sheet system is presented utilizing one or more separable sheets removably affixed to an associated bound sheet of a collection of bound sheets such as a book, magazine, pamphlet, brochure, or other publication. Binding of the collection of bound sheets can be accomplished by conventional methods for binding books, magazines, pamphlets or other such binding methods such as spiral binding, multiple ring binding such as used with three ring binders, staple binding, or other such binding according to conventional methods. The type of binding found with a particular collection of bound sheets is not of primary relevance as to how the separable sheet system is implemented with the particular collection of bound sheets since the separable sheet system is conducive for use with collections of bound sheets in general regardless of the particular method used for binding a particular collection of bound sheets.

The separable sheet system addresses numerous types of frustrations repeated in homes and other locations such as when one incorrectly transcribes from a cookbook ingredients for a recipe; subsequently shops; and upon returning from shopping finds that a more time and fuel wasting shopping trip is necessary to complete the hunt for ingredients of the recipe. The separable sheet system generally provides a mechanism for users of information contained in a bound collection of sheets to remove a separable sheet removably affixed to an associated one of the bound sheets. The separable sheet contains information, such as an identification of one or more articles, for instance, an accurate list of ingredients, to be used elsewhere without the necessity of taking the entire book, magazine, or other type of bound collection of sheets along or without the necessity of resorting to the error prone procedure of transcribing information. The separable sheet would typically include text and/or graphics to provide such information as identification of one or more articles of some particular nature as discussed further below.

For instance, with the separable sheet system, a user of a cookbook can remove an exact duplicate of an ingredient list or list of food items from the cookbook for a trip to the grocery store, without the user having to transcribe the ingredients onto another piece of paper. Besides cookbooks, the separable sheet system can be applied to other types of books, magazines, and some other bound collection of sheets containing information including “how to” instructions, other sorts of instructions or actions to be performed, parts or material lists, exercise routines, plans, lessons, or samples such as pattern or color samples. In some implementations, the lessons can include at least one of the following: formulas, summaries, and diagrams. In some of the implementations, the exercise routines can be described by using at least one of the following: instructions, diagrams, and photographs. Other examples of applications for the separable sheets system include arts and crafts books, children's books and workbooks, cookbooks and diet books, exercise books, such as books on yoga positions, other exercise positions and/or instructions for other exercise execution, home improvement books, how to books, interior design books (which may include color swatches or paint samples), cooking magazines, other specialty books and magazines, textbooks and study guides for students, portions of lessons, and lesson plans for teachers, and such plans having planned events or tasks to be performed.

One or more of the separable sheets can be positioned to cover a portion of the associated bound sheet that also displays the same set of information contained in the separable sheet. The display of the set of information on the separable sheet and the associated bound sheet can be identical or can vary depending upon the particular implementation involved. In some implementations, positioning of the separable sheet onto the associated bound sheet is quite precise so that the presentation of information and positioning of the presentation are nearly identical whether viewing the associated bound sheet or the separable sheet affixed to the associated bound sheet. In these precise implementations, orientation of the separable sheet with respect to the associated bound sheet and affixing of the separable sheet onto the associated bound sheet is sufficiently flush or even that the appearance of the associated sheet or other bound sheets of the bound collection of sheets is not impaired by the affixing of the separable sheet onto the associated bound sheet.

In other implementations, positioning of the separable sheet on the associated bound sheet does not demand as much precision. Generally, the information on the separable sheet is also found with the associated bound sheet so that the information on the separable sheet can still be found on the associated bound sheet after the separable sheet has been removed from the bound collection of sheets. In yet other implementations, the position of the separable sheet is unrelated to the position of the corresponding information on the bound sheet. Depending upon the implementation, there may be only one or there may be a plurality of separable sheets removably affixed to a particular associated bound sheet and the plurality of separable sheets may be stacked on top of one another. If the separable sheets are stacked on top of one another they can be removably affixed to the associated bound sheet either independent from one another or by a first one of the separable sheets being removably affixed to the associated bound sheet and with the others of the separable sheets of the stack removably affixed to one another.

Various technologies can be employed regarding how one or more separable sheets are removably affixed to an associated bound sheet. For instance, a separable sheet can be removably affixed to an associated bound sheet through use of repositionable pressure-sensitive adhesive media such as offered through Post-It products by Minnesota Mining and Manufacturing Company in which case a separable sheet can be re-affixed to its associated bound sheet. Another method of removable affixation of the separable sheet to the associated bound sheet can be done through removable non-repositionable media such as that offered through iTSA note products by Taylor Corporation in which case a separable sheet cannot be re-affixed to its associated bound sheet.

Various ways to removably affix the separable sheets to the associated bound sheets can then address various issues that arise regarding different types of media that constitute the bound sheets such as whether the bound sheets are coated or uncoated. For instance, coated paper is commonly used with hardcover books, however, certain types of technology to removably affix a separable sheet, such as some non-repositionable media and some repositionable media, could harm the associated bound sheet by delaminating, tearing, or otherwise defacing the associated bound sheet. Other adhesives and adhesive processes allow for a wider variety of materials for the associated bound sheet as known in the art.

The separable sheets may be made of paper, acrylic, other forms of plastic, a combination of such materials or other such materials and adhesives that would provide a sheet surface to be printed upon or otherwise receive text and graphics for non-volatile display of information. Generally, the separable sheets will have an opaque nature to help display of the information contained thereon.

Placement of the separable sheets onto the associated bound sheets can be done manually or by mechanical means. Manual application might be slow and inefficient, but such a process could be utilized. Alternatively, a particular publishing company may apply its own familiar printing technology to implement the separable sheet system. One skilled in the art would recognize that printing technologies are quite varied throughout the printing industry and offer numerous methods of printing the separable sheet, applying adhesive or other affixing mechanism to either the associated bound sheet, the separable sheet or both, and have different approaches in applying varying amounts, pressures and timing sequences necessary to place and otherwise secure one or more separable sheets to an associated bound sheet.

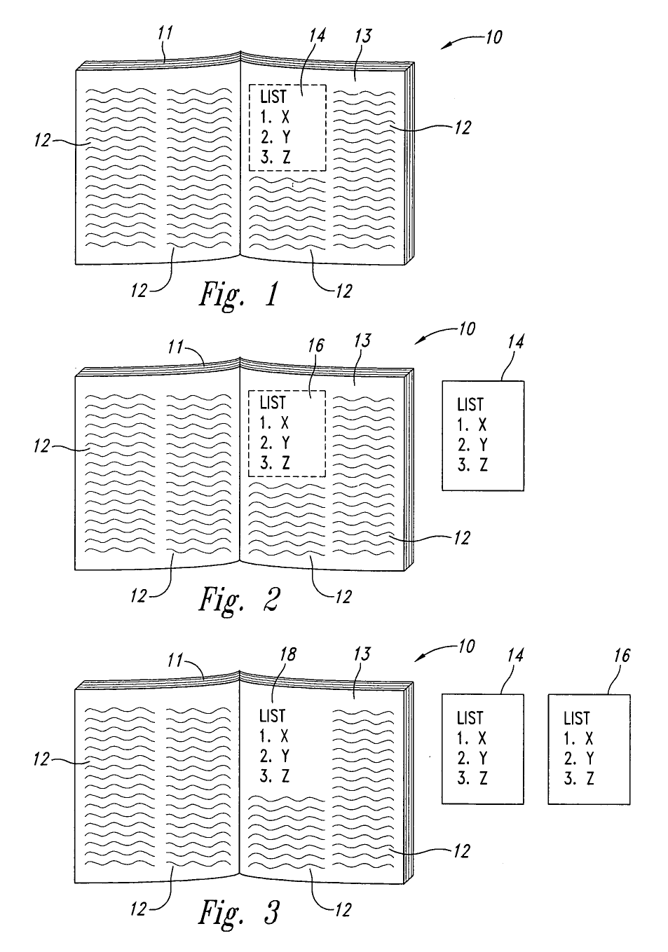

A separable sheet system 10 is shown in FIG. 1 as being contained within a bound collection of sheets 11 having at least one associated bound sheet 13 with bound sheet portions 12 and a separable sheet 14 removably affixed thereto. The bound sheet portions 12 contain text and/or graphics typically found in books, magazines or other types of bound collections of sheets. In the exemplary implementation depicted in FIG. 1, the separable sheet 14 contains text and/or graphics as generally representing a list of items. In some implementations, the graphics can include such things as at least one of the following: color swatches, paint color samples, patterns, fabric swatches, drawings, diagrams, and photographs. In other implementations, such as those discussed below, the separable sheet system 10 includes other types of separable sheets and the separable sheet 14 includes other types of information.

The separable sheet 14 can be removed to expose a second separable sheet 16 as shown in FIG. 2. Generally, the second separable sheet 16 would have identical text and/or graphics as the separable sheet 14. This first depicted example of the separable sheet system 10 is initially configured to have two separable sheets removably affixed: the separable sheet 14 and the second separable sheet 16. In a first set of implementations, the separable sheet could be removably affixed directly to the second separable sheet 16 whereas in a second set of implementations the separable sheet 14 could be removably affixed directly to the associated bound sheet 13. In the second set of implementations, the separable sheet that is adjacent to the associated bound sheet 13 (the second separable sheet 16 for the case depicted in FIG. 1) would be removably affixed directly to the associated bound sheet 13.

Removal of the second separable sheet 16 from the associated bound sheet 13 exposes an overlaid bound sheet portion 18 as depicted in FIG. 3. In some implementations, the overlaid bound sheet portion 18 generally contains all or portions of identical text and/or graphics of the separable sheet 14 and the second separable sheet 16 as is shown in FIG. 3. In other implementations, the overlaid bound sheet portion 18 can include text and/or graphics other than or in addition to that found on the second separable sheet 16.

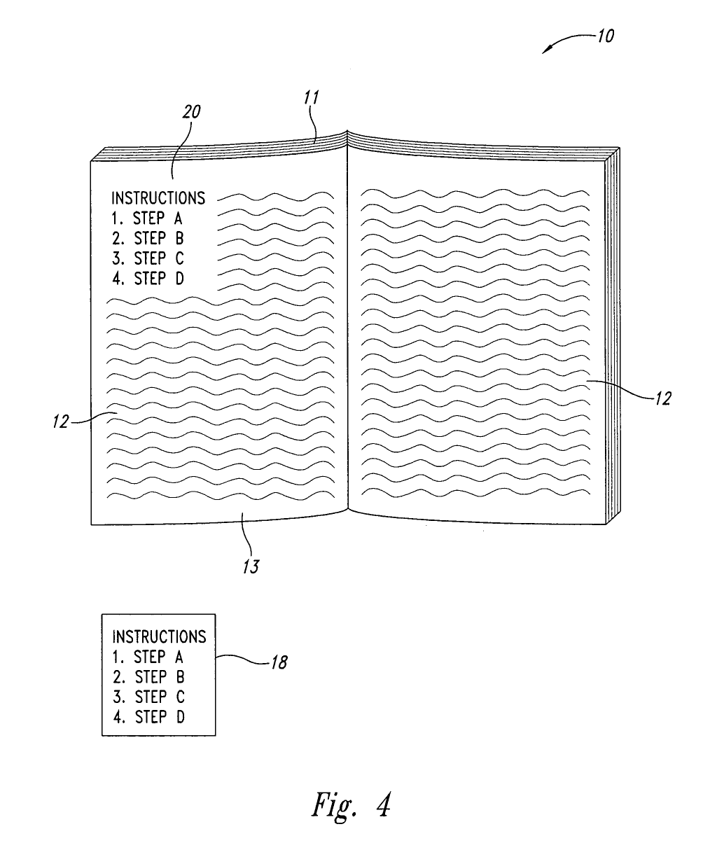

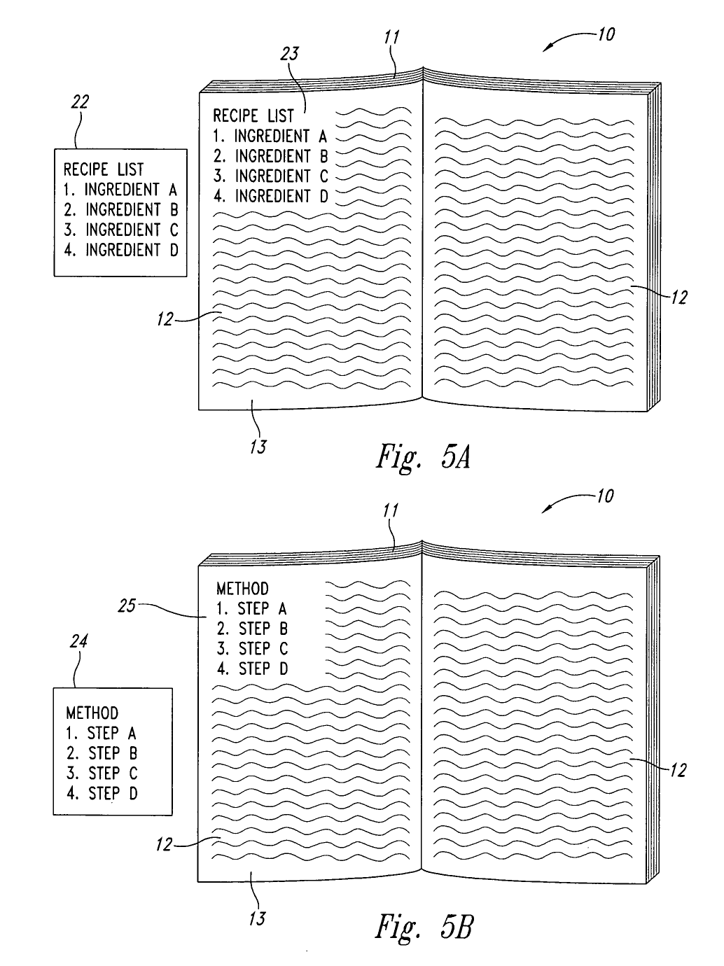

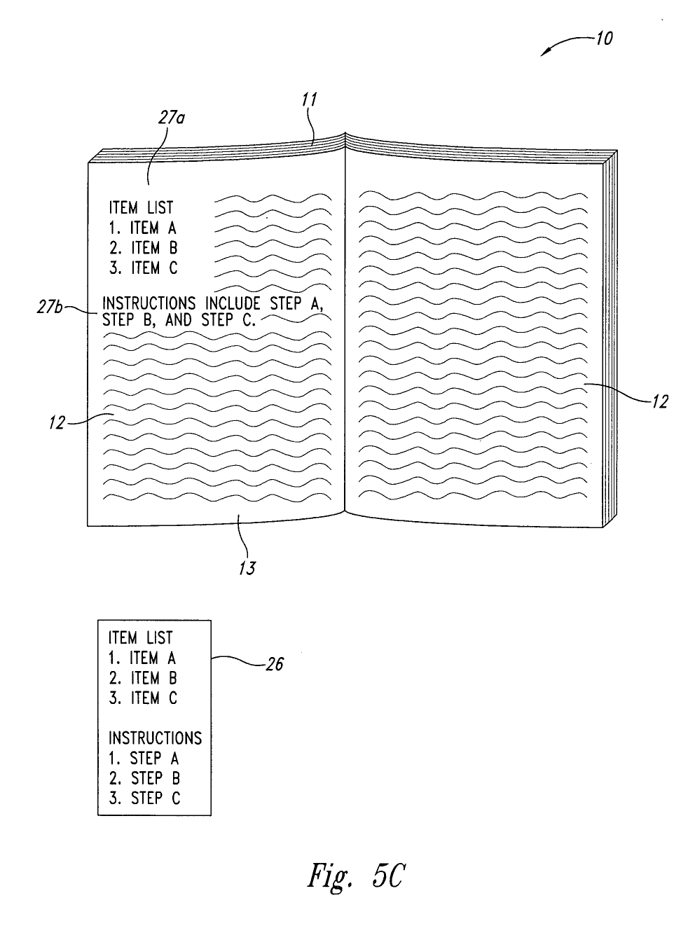

A second implementation of the separable sheet system 10 is shown in FIG. 4 as having a separable sheet 18 and an overlaid bound sheet portion 20 displaying a representative set of instructions. A third implementation of the separable sheet system 10 is shown in FIG. 5A as having a separable sheet 22 and an overlaid bound sheet portion 23 displaying a representative recipe.

A fourth implementation of the separable sheet system 10 is shown in FIG. 5B as having a separable sheet 24 and an overlaid bound sheet portion 25 displaying a representative method.

A fifth implementation of the separable sheet system 10 is shown in FIG. 5C as having a separable sheet 26 including two portions: an item list and instructions, an overlaid bound sheet portion 27a including the item list, and a text portion 27b of the bound sheet portions 12 including the instructions

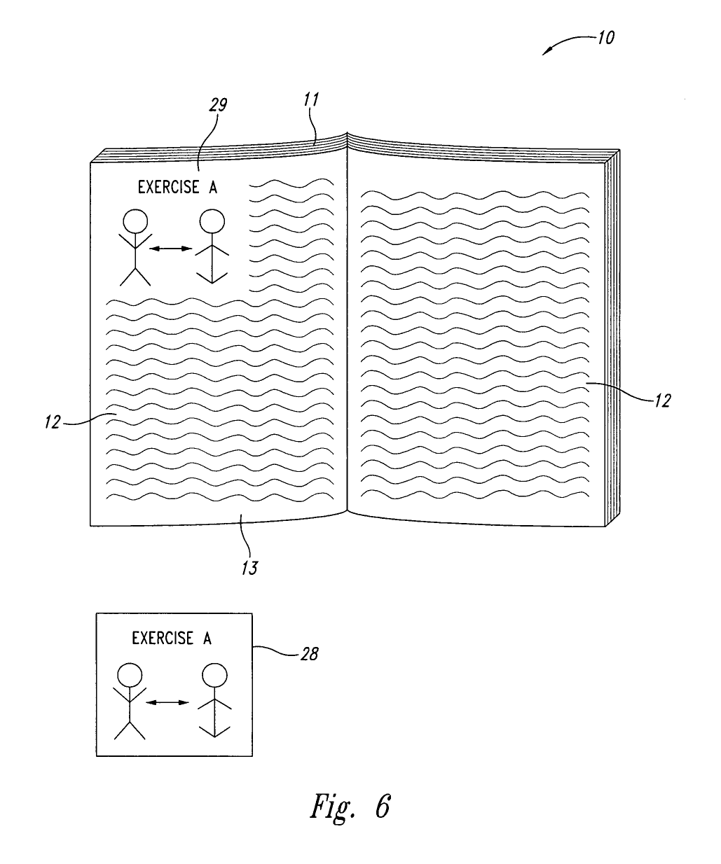

A sixth implementation of the separable sheet system 10 is shown in FIG. 6 as having a separable sheet 28 and an overlaid bound sheet portion 29 displaying a representative exercise summary.

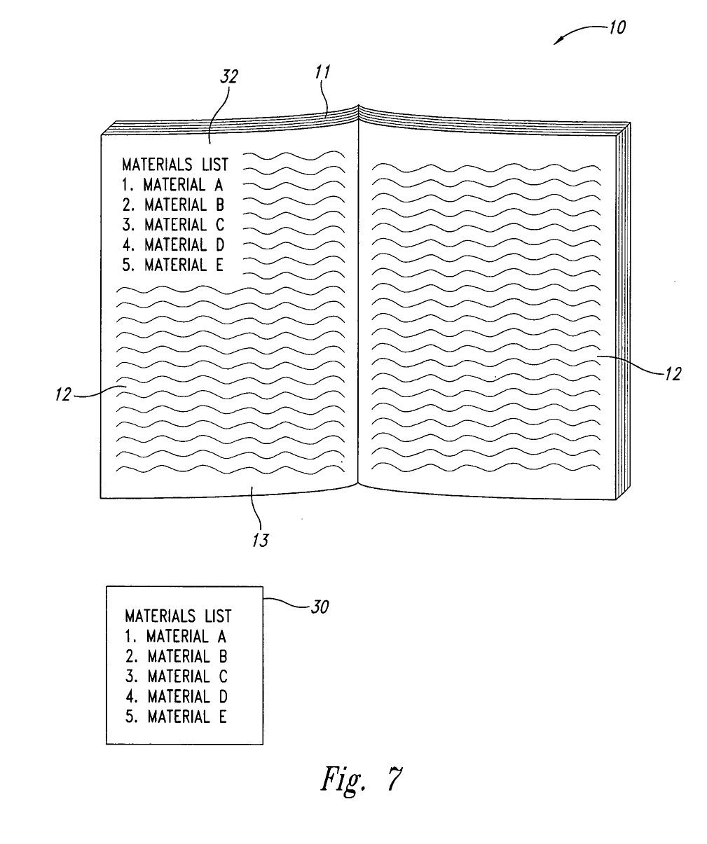

A seventh implementation of the separable sheet system 10 is shown in FIG. 7 as having a separable sheet 30 and an overlaid bound sheet portion 32 displaying a representative materials list such as for a home improvement project.

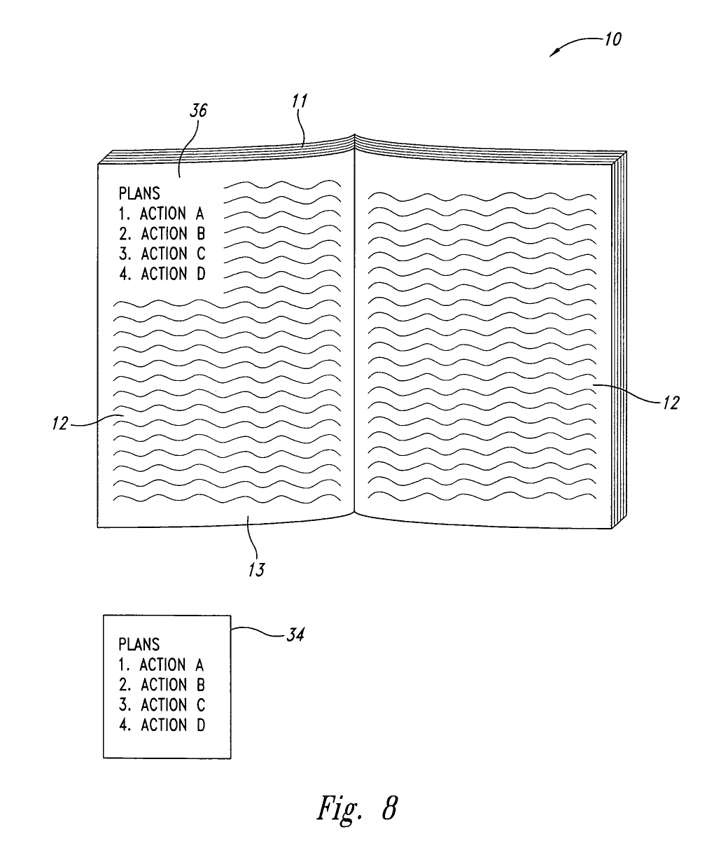

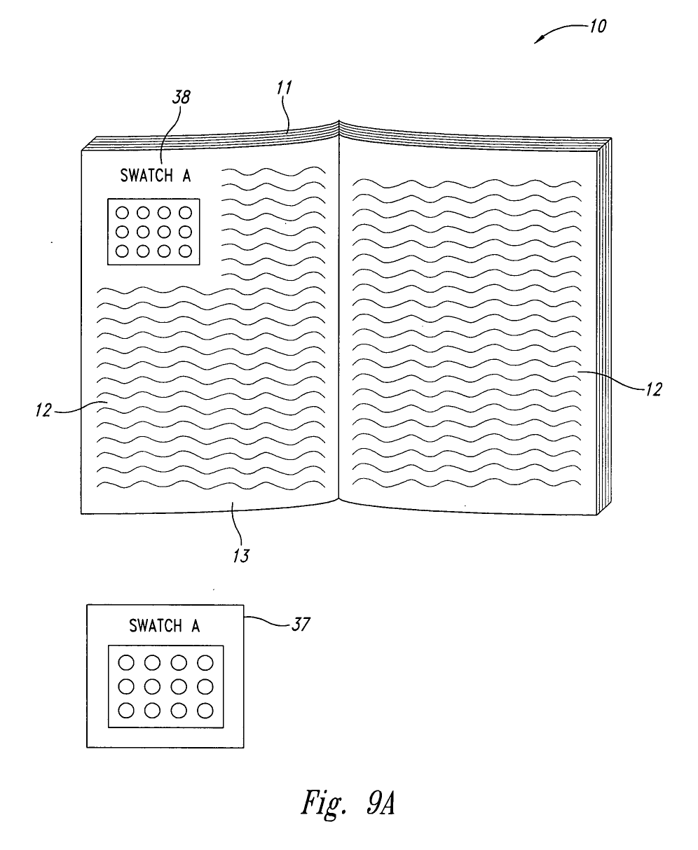

A eighth implementation of the separable sheet system 10 is shown in FIG. 8 as having a separable sheet 34 and an overlaid bound sheet portion 36 displaying a representative set of plans.

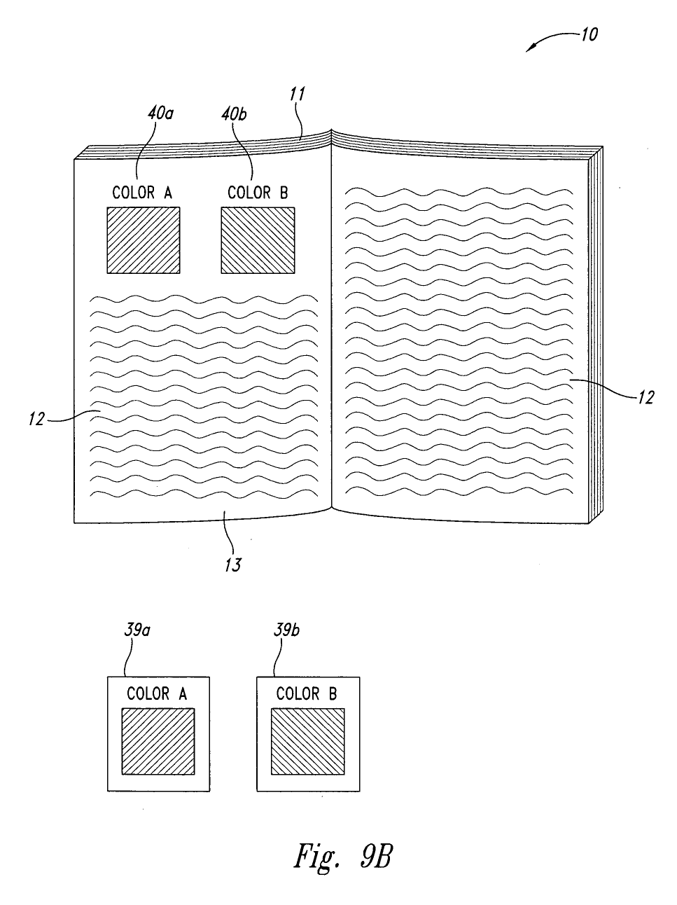

A ninth implementation of the separable sheet system 10 is shown in FIG. 9A as having a separable sheet 37 and an overlaid bound sheet portion 38 displaying a representative fabric swatch.

A tenth implementation of the separable sheet system 10 is shown in FIG. 9B as having a first separable sheet 39a and a second separable sheet 39b and a first overlaid bound sheet portion 40a and a second overlaid bound sheet portion 40b displaying representative color samples.

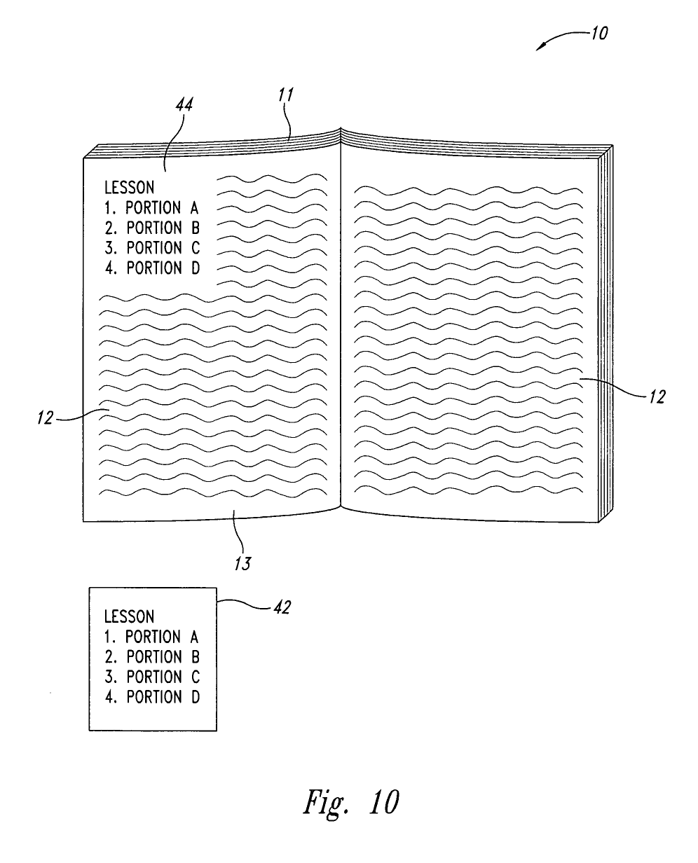

An eleventh implementation of the separable sheet system 10 is shown in FIG. 10 as having a separable sheet 42 and an overlaid bound sheet portion 44 displaying a representative lesson set.

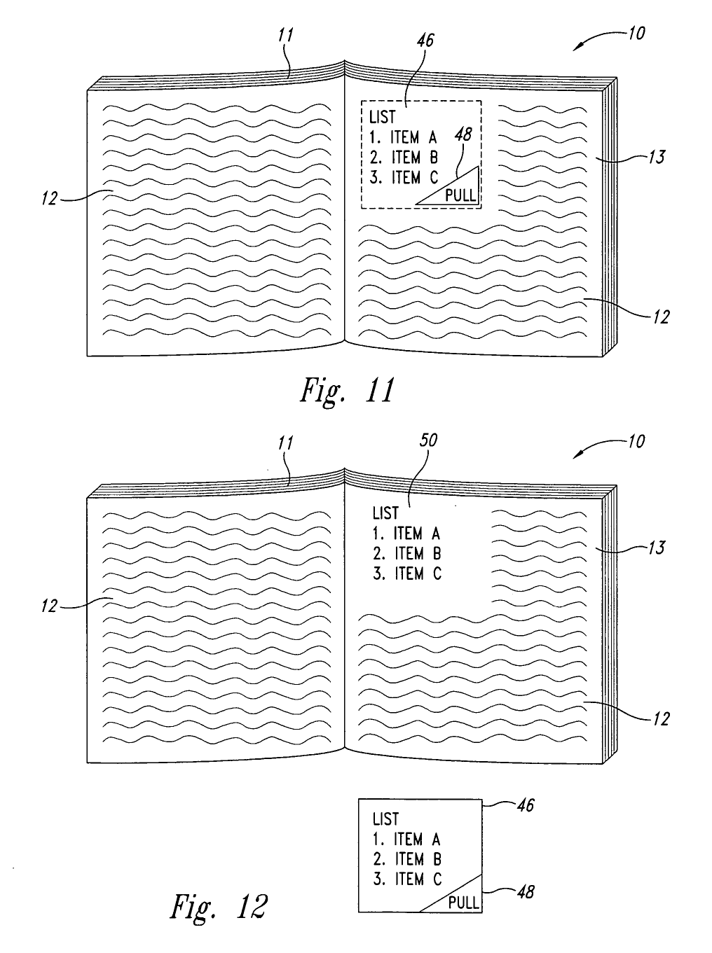

A twelfth implementation of the separable sheet system 10 is shown in FIG. 11 as having a separable sheet 46 with a pull tab 48 typically demarcated with one or more words such as “pull”. The separable sheet 48 is shown removed from an overlaid bound sheet portion 50 of the associated bound sheet 13 in FIG. 12. Removal of the separable sheet 48 can be accomplish by a user pulling or grasping on the pull tab 48. The pull tab 48 can serve as indication of the presence of the separable sheet 46 when it is removably attached to the overlaid bound sheet portion 50 such as in the case where the separable sheet is precisely placed and removably affixed to the overlaid bound sheet portion so that an untrained eye may not realize its removable nature.

In some implementations, separable sheets, such as the separable sheet 48, can be affixed to the overlaid bound sheet portions, such as the overlaid bound sheet portion 50, with a repositionable adhesive so that once removed, the separable sheets can be re-affixed to the overlaid bound sheet portions if desired.

It will therefore be readily understood by those persons skilled in the art that the present invention is susceptible of broad utility and application. Many embodiments and adaptations of the present invention other than those herein described, as well as many variations, modifications and equivalent arrangements, will be apparent from or reasonably suggested by the present invention and the foregoing description thereof, without departing from the substance or scope of the present invention. Accordingly, while the present invention has been described herein in detail in relation to its preferred embodiments, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements, the present invention being limited only by the claims appended hereto and the equivalents thereof.

The invention claimed is:

1. A system comprising:
a plurality of printed sheets, one of the plurality of printed sheets being an associated sheet, the associated sheet having an overlaid portion; and
a separable sheet having a first identification of one or more articles, the separable printed sheet being removably affixed to the overlaid portion of the associated sheet.

2. The system of claim 1 wherein the separable sheet is printed.

3. The system of claim 1 wherein the separable printed sheet has the first identification to include at least one of the following: text and graphics.

4. The system of claim 3 wherein the graphics comprise at least one of the following: color swatches, paint color samples, fabric swatches, patterns, drawings, diagrams, and photographs.

5. The system of claim 1 wherein the overlaid portion of the associated sheet is printed with the first identification.

6. The system of claim 1 wherein the plurality of printed sheets is bound.

7. The system of claim 1 wherein the plurality of printed sheets is configured to be a portion of one of the following: a book, a periodical, a pamphlet, and a brochure.

8. The system of claim 1 wherein the separable printed sheet has the first identification of articles as food items.

9. The system of claim 1 wherein the separable printed sheet has the first identification of articles as materials.

10. The system of claim 1 wherein the separable printed sheet has the first identification of articles as actions to be performed.

11. The system of claim 1 wherein the separable printed sheet has the first identification of articles as at least one of the following: ingredients and items.

12. The system of claim 1 wherein the separable printed sheet has the first identification of articles as portions of lessons.

13. The system of claim 1 wherein the portions of lessons include at least one of the following: formulas, summaries, and diagrams.

14. The system of claim 1 wherein the separable printed sheet has the first identification of articles includes at least one of instructions, diagrams, and photographs associated with exercise positions.

15. The system of claim 1 wherein the separable printed sheet has the first identification of articles as planned events.

16. The system of claim 1 wherein the separable printed sheet has the first identification of articles as tasks comprising actions to be performed.

17. The system of claim 1 wherein the separable printed sheet has the first identification of articles as color samples.

18. The system of claim 1 wherein the separable printed sheet has the first identification of articles as paint samples.

19. The system of claim 1 wherein the separable printed sheet has the first identification of articles as parts.

20. The system of claim 1 wherein the separable sheet is at least in part made from at least one of the following materials: paper, acrylic, and plastic.

21. The system of claim 1 wherein the separable sheet is removably attached to the overlaid portion of the associated sheet by pressure-sensitive adhesive.

22. The system of claim 1 wherein the separable sheet is repositionable removable media.

23. The system of claim 1 wherein the separable sheet is non-repositionable removable media.

24. A cookbook comprising:
a plurality of printed bound sheets including at least one of the following: a plurality of ingredients list and a plurality of recipes, one of the plurality of sheets being an associated sheet, the associated sheet having an overlaid portion; and
a separable printed sheet having an ingredients list, the separable printed sheet being removably affixed to the overlaid portion of the associated sheet.

25. The cookbook of claim 24 wherein the separable sheet further includes at least one of the following: a plurality of recipes and a plurality of items.

26. The cookbook of claim 24 wherein the overlaid portion of the associated sheet is printed with the ingredients list.

27. An exercise manual comprising:
a plurality of printed bound sheets, one of the plurality of sheets being an associated sheet, the associated sheet having an overlaid portion; and
a separable printed sheet having instructions for at least one execution of an exercise, the separable printed sheet being removably affixed to the overlaid portion of the associated sheet.

28. The exercise manual of claim 28 wherein the overlaid portion of the associated sheet is printed with at least one of the following: diagrams, photographs and the instructions.

29. A system comprising:
a plurality of printed sheets, one of the plurality being an associated sheet, the associated sheet having an overlaid portion; and
a separable sheet having information related to a task described on the associated sheet to be performed using the information.

30. The system of claim 29 wherein the overlaid portion of the associated sheet is printed with the information.

31. The system of claim 25 wherein the information is presented in a list format.

32. The system of claim 31 wherein the list of information includes at least one of the following: text and graphics.

33. The system of claim 29 wherein the plurality of printed sheets is bound.

34. The system of claim 29 wherein the plurality of printed sheets is configured to be a portion of one of the following: a book, a periodical, a pamphlet, and a brochure.

35. The system of claim 29 wherein the separable printed sheet has information including ingredients and the associated sheet describes the task of preparing a food product using the ingredients.

36. The system of claim 29 wherein the separable printed sheet has information including materials and the associated sheet describes the task of creating an end product using the materials.

37. The system of claim 29 wherein the separable printed sheet has information including portions of a lesson and the associated sheet describes the task of performing the lesson.

38. The system of claim 29 wherein the separable printed sheet has information including exercise positions and the associated sheet describes the task of performing the exercise.

39. A method for transferring information from a first location at which a book is located to a second location at which the book is not located, the information regarding identification of at least one article, the method comprising:
grasping a separable sheet containing the information, the separable sheet being removably affixed to a page of the book;
pulling the separable sheet to remove the separable sheet from the page of the book; and
carrying the separable sheet from the first location to the second location without the book.
